(19) United States
(12) Patent Application Publication
(10) Pub. No.: US 2025/0283839 A1
(43) Pub. Date: Sep. 11, 2025

(54) METHOD AND APPARATUS FOR MANUFACTURING ALL-SOLID-STATE BATTERY

(71) Applicants: MEERE COMPANY INC., Hwaseong-si Gyeonggi-do (KR); SAMSUNG SDI CO., LTD., Yongin-si Gyeonggi-do (KR)

(72) Inventors: Ja Woo LEE, Hwaseong-si Gyeonggi-do (KR); Hae Young JEON, Anseong-si Gyeonggi-do (KR)

(73) Assignees: MEERE COMPANY INC., Hwaseong-si Gyeonggi-do (KR); SAMSUNG SDI CO., LTD., Yongin-si Gyeonggi-do (KR)

(21) Appl. No.: 19/220,284

(22) Filed: May 28, 2025

Related U.S. Application Data
(63) Continuation of application No. PCT/KR2023/095078, filed on Nov. 16, 2023.

(30) Foreign Application Priority Data
Nov. 28, 2022 (KR) 10-2022-0161992

(51) Int. Cl. G01N 23/18; G01N 23/046; H01M 10/04

(52) U.S. Cl. CPC G01N 23/18; G01N 23/046; H01M 10/0404; H01M 10/0468; G01N 2223/611; G01N 2223/646

(57) ABSTRACT

The present disclosure relates to a method of manufacturing an all-solid state battery, and more specifically, is to provide a method of manufacturing an all-solid state battery, in which performance degradation factors of all-solid-state batteries are identified through a non-destructive inspection, and the performance degradation factors are used to determine the performance of a cell and evaluate and change a manufacturing process of the cell.

### CROSS-REFERENCE TO RELATED APPLICATIONS

This application is a continuation of International Application No. PCT/KR2023/095078 filed on Nov. 16, 2023, which claims priority to Korean Patent Application No. 10-2022-0161992 filed on Nov. 28, 2022, the entire contents of which are herein incorporated by reference.

### TECHNICAL FIELD

The present disclosure relates to a method and apparatus for manufacturing an all-solid state battery.

### BACKGROUND ART

Today, secondary batteries are used in various fields of small devices such as mobile phones, camcorders, and laptops as well as large devices such as vehicles and power storage systems. As the application fields of secondary batteries are expanding, there is an increasing demand to improve the safety of batteries and achieve high performance of the batteries.

The most widely used lithium secondary batteries have the advantages of higher energy density and higher capacity per unit area as compared to nickel-manganese batteries or nickel-cadmium batteries. A lithium secondary battery includes a positive electrode, a negative electrode, an electrolyte, and a separator. The electrolyte is a liquid electrolyte including a flammable organic solvent, and as lithium ions move between the positive electrode and the negative electrode through the electrolyte, charging/discharging occurs. Safety issues of lithium secondary batteries have been consistently raised due to fires and explosions caused by the leakage of the electrolyte.

Recently, there has been an increasing interest in all-solid state batteries in which, in order to improve the safety of these lithium secondary batteries, a liquid electrolyte is replaced with a solid electrolyte to solidify materials inside batteries. Since all-solid state batteries have no risk of electrolyte leakage and do not require a separator, battery structures may be simplified, and a reduction in manufacturing cost and an improvement in productivity may be expected. In addition, since solid electrolytes have a higher density and lower molecular mobility as compared to liquid electrolytes, it is possible to manufacture batteries with a large energy capacity per size, thereby realizing large-capacity secondary batteries for electric vehicles or the like.

All-solid state batteries are manufactured by providing raw materials of a negative electrode, a solid electrolyte, and a positive electrode in the form of solid powder and generally stacking the negative electrode, the solid electrolyte, and the positive electrode in the form of slurry. In this case, pores may be formed or foreign materials may be introduced into each layer to generate defects. Since solid electrolytes are not fluid, the movement of lithium ions may be restricted by the defects, and battery performance may be significantly degraded. Therefore, there is a need to identify defects caused by the above-described pores or foreign materials and find solutions to solve the defects.

### DISCLOSURE OF INVENTION

### Technical Problem

The present disclosure is directed to providing a method and apparatus for manufacturing an all-solid state battery, which is capable of identifying defects or foreign materials present inside an all-solid state battery, predicting performance, and changing process conditions when performance is unsuitable.

### Solution to Problem

An aspect of the present disclosure provides a method of manufacturing an all-solid state battery, the method including manufacturing, by a cell manufacturing unit, a cell comprising a solid electrolyte, radiographing, by an imaging unit, the cell to obtain a first image, uniformly pressing, by a pressing unit, the cell, radiographing, by the imaging unit, the pressed cell to obtain a second image, processing, by a control unit, the first image to detect first inactive area information, and processing the second image to detect second inactive area information, and deriving, by the control unit, inactivity of the cell by using the first inactive area information or the second inactive area information, and comparing the inactivity of the cell with a preset reference value to determine whether the cell is suitable.

### Advantageous Effects of Invention

In a method and apparatus for manufacturing an all-solid state battery according to an embodiment of the present disclosure, performance degradation factors of all-solid-state batteries are identified through a non-destructive inspection, and thus the performance degradation factors are used to determine the performance of a cell and evaluate and change a manufacturing process of the cell.

### BRIEF DESCRIPTION OF DRAWINGS

FIG. 1 is a block diagram for describing an apparatus for manufacturing an all-solid state battery according to an embodiment of the present disclosure.

FIG. 2 is a flowchart briefly illustrating a method of manufacturing an all-solid state battery according to an embodiment of the present disclosure.

FIG. 3 shows conceptual diagrams for describing a method of detecting inactive area information by processing an image.

FIG. 4 shows conceptual diagrams for describing a method of processing an image by distinguishing between an inactive area due to pores and an inactive area due to foreign materials in an image.

FIGS. 5A and 5B show images showing a case in which inactivity is reduced when a first image is compared with a second image.

FIGS. 6A and 6B show images showing a case in which inactivity is increased when the first image is compared with the second image.

### BEST MODE FOR CARRYING OUT THE INVENTION

An aspect of the present disclosure provides a method of manufacturing an all-solid state battery, the method including manufacturing, by a cell manufacturing unit, a cell comprising a solid electrolyte, radiographing, by an imaging unit, the cell to obtain a first image, uniformly pressing, by a pressing unit, the cell, radiographing, by the imaging unit, the pressed cell to obtain a second image, processing, by a control unit, the first image to detect first inactive area information, and processing the second image to detect second inactive area information, and deriving, by the control unit, inactivity of the cell by using the first inactive area information or the second inactive area information, and comparing the inactivity of the cell with a preset reference value to determine whether the cell is suitable.

In addition, the method may further include, after the determining of whether the cell is suitable, when it is determined that the cell is unsuitable according to the reference value, controlling, by the control unit, the cell manufacturing unit or the pressing unit by changing manufacturing conditions or uniform pressing conditions of the cell by using the first inactive area information or the second inactive area information.

In addition, the controlling of the cell manufacturing unit or the pressing unit may include comparing the first inactive area information of the first image with the second inactive area information of the second image, and changing the manufacturing conditions or the uniform pressing conditions of the cell according to a rate of change in inactivity of the cell before and after the pressing.

In addition, the first inactive area information and the second inactive area information may be information about at least one of a brightness value, a brightness distribution, a pixel number, a pixel size, and a pixel area which are for each pixel of the first image and the second image.

In addition, the determining of whether the cell is suitable may include deriving the inactivity of the cell according to Equation 1 below:

Inactivity (%)=[area A₂ of second inactive area/total area Aₜₒₜₐₗ inside cell]×100. [Equation 1]

In addition, the cell may be a mono-cell or a stack cell.

In addition, the imaging unit may be an X-ray device or a three-dimensional computed tomography (CT) scanner.

Another aspect of the present disclosure provides an apparatus for manufacturing an all-solid state battery, the apparatus including a cell manufacturing unit configured to manufacture a cell comprising a solid electrolyte, a pressing unit configured to uniformly press the cell, an imaging unit configured to obtain a first image or a second image by radiographing the cell, and a control unit configured to process the first image to detect first inactive area information, process the second image to detect second inactive area information, derive inactivity of the cell by using the first inactive area information or the second inactive area information, and compare the inactivity of the cell with a preset reference value to determine whether the cell is suitable.

In addition, when it is determined that the cell is unsuitable according to the reference value, the control unit may be further configured to control the cell manufacturing unit or the pressing unit by changing manufacturing conditions or uniform pressing conditions of the cell by using the first inactive area information or the second inactive area information.

In addition, when the control unit controls the cell manufacturing unit or the pressing unit, the first inactive area information of the first image may be compared with the second inactive area information of the second image, and the manufacturing conditions or the uniform pressing conditions of the cell may be changed according to a rate of change in inactivity of the cell before and after the pressing.

In addition, the first inactive area information and the second inactive area information may be information about at least one of a brightness value, a brightness distribution, a pixel number, a pixel size, and a pixel area which are for each pixel of the first image and the second image.

In addition, in the determining of whether the cell is suitable, the inactivity of the cell may be derived according to Equation 1 below:

$$Inactivity ( \% ) = [ area {A}_{2} of second inactive area / total area {A}_{total} inside cell ] \times 100. \qquad [ Equation 1 ]$$

In addition, the cell may be a mono-cell or a stack cell.

In addition, the imaging unit may be an X-ray device or a three-dimensional CT scanner.

### MODE FOR THE INVENTION

Hereinafter, the following embodiments will be described in detail with reference to the accompanying drawings, wherein like reference numerals refer to the same or corresponding components throughout the drawings, and a redundant description thereof will be omitted.

The present embodiments may have various modifications, and thus specific embodiments are illustrated in the drawings and described in detail in the detailed description. The effects and features of the present embodiments and methods for achieving them will be apparent with reference to the following detailed description together with the drawings. However, the present embodiments are not limited to the embodiments disclosed below and may be implemented in various forms.

In the following embodiments, the terms first, second, and the like do not have limited meaning but are used for the purpose of distinguishing one component from another component.

In the following embodiments, the expressions used in the singular such as “a,” “an,” and “the” are intended to include the plural forms as well, unless the context clearly indicates otherwise.

In the following embodiments, it will be understood that the terms such as “including,” “comprising,” and “having” specify the presence of stated features or components, but do not preclude the presence or addition of one or more other features or components.

In the following embodiments, when a unit, an area, a component, or the like is positioned on or above another part, the present disclosure includes not only a case in which the unit, the area, the component, or the like is positioned directly above the other part, but also a case in which other units, other areas, other component, or the like may be positioned therebetween.

In the following embodiments, unless the terms “connecting” or “coupling” are clearly different in context, the terms “connecting” or “coupling” do not necessarily mean direct and/or fixed connection or coupling of two members, but do not exclude a member positioned between the two members.

Terms as used herein mean that the features or components described in the specification are present, and do not preclude the possibility that one or more other features or components will be added.

In the drawings, components may be exaggerated or reduced in size for convenience of description. For example, the sizes and thicknesses of the respective components shown in the drawings are arbitrarily shown for convenience of description, and thus the following embodiments are not necessarily limited thereto.

In the present disclosure, the term “cell” refers to an all-solid state battery and includes a negative electrode including a negative electrode active material, a positive electrode including a positive electrode active material, and a solid electrolyte disposed between the negative electrode and the positive electrode.

The term “active material” refers to a material that may chemically react to generate electrical energy. As lithium ions are intercalated or deintercalated into or from the active material, an electrochemical oxidation reaction or reduction reaction occurs.

The term “active” means that electrons or ions move to charge or discharge the cell.

The term “inactive area” refers to an electrochemically inactive area and means a portion at which, due to at least one pore or foreign material present inside the cell, a density of a portion inside the cell is lowered to cause a deviation in ionic conductivity of a solid electrolyte.

The term “active area” refers to an electrochemically active area and means the remaining area excluding the inactive area in the cell.

The term “degree of inactivity” is an approximate value of the performance of the cell and refers to an extent or proportion of the inactive area of the cell.

The term “pixel” refers to the smallest unit that constitutes an image. The smaller the pixel size, the higher the resolution of the image, and the more pixels included within the same range, the higher the resolution.

The term “voxel” refers to a regular grid unit value in a three-dimensional space and means the smallest unit that constitutes a three-dimensional image.

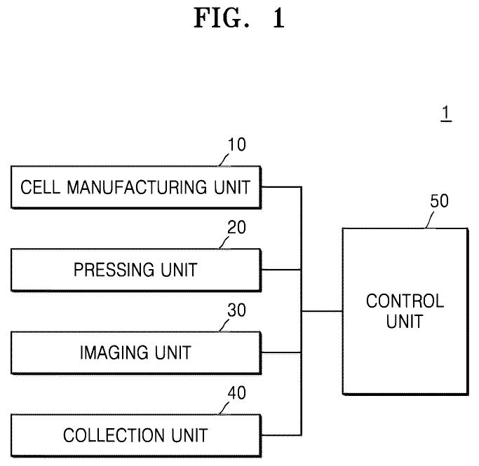

FIG. 1 is a block diagram for describing an apparatus for manufacturing an all-solid state battery according to an embodiment of the present disclosure.

Referring to FIG. 1, an apparatus 1 for manufacturing an all-solid state battery according to an embodiment of the present disclosure may include a cell manufacturing unit 10, a pressing unit 20, an imaging unit 30, a collection unit 40, and a control unit 50.

The cell manufacturing unit 10 may be provided to manufacture a cell including a solid electrolyte. The cell may be an all-solid state battery and may include a negative electrode, a positive electrode, and a solid electrolyte.

In the cell manufacturing unit 10, the cell may be manufactured by arranging the solid electrolyte between the negative electrode and the positive electrode.

Specifically, the cell may be manufactured in a layered structure by sequentially stacking the negative electrode, the solid electrolyte, and the positive electrode.

The negative electrode may include a negative electrode current collector and a negative electrode active material layer formed on a surface of the negative electrode current collector. The negative electrode active material layer may include a negative electrode active material, and the negative electrode active material may include a lithium metal.

The negative electrode active material layer may be formed by stacking a lithium metal thin film on a surface of the current collector or electrochemically depositing a lithium metal on the surface of the current collector, or may be formed through a chemical or physical vapor deposition method.

As the negative electrode active material, any negative electrode active material may be used as long as the negative electrode active material may be commonly used in a negative electrode of a lithium secondary battery. For example, the negative electrode active material may include carbon such as non-graphitizable carbon or graphite-based carbon (natural graphite or artificial graphite), a metal composite oxide such as LiₓFe₂O₃ (0≤x≤1), LiₓWO₂ (0≤x≤1), or SnₓMe₁₋ₓMe′_{y}O_{z} (Me: Mn, Fe, Pb, or Ge; Me′: Al, B, P, Si, an element of Group 1, Group 2, or Group 3 element of the periodic table, or a halogen; 0<x≤1; 1≤y≤3; and 1≤z≤8), a lithium metal, a lithium alloy, a silicon-based alloy, a tin-based alloy, a metal oxide such as SnO, SnO₂, PbO, PbO₂, Sb₂O₃, GeO, GeO₂, Bi₂O₃, or Bi₂O₄, a conductive polymer such as polyacetylene, a Li—Co—Ni-based material, titanium oxide, lithium titanium oxide, or a combination thereof, but one or more embodiments are not limited thereto.

The positive electrode may include a positive electrode current collector and a positive electrode active material layer formed on a surface of the positive electrode current collector. The positive electrode active material layer may include a positive electrode active material, and the positive electrode active material may include a sulfur compound.

As the positive electrode active material, any positive electrode active material may be used as long as the positive electrode active material may be commonly used in a positive electrode of a lithium secondary battery. For example, the positive electrode active material may be lithium oxide. Specifically, the positive electrode active material may include a layered compound such as lithium cobalt oxide (LiCoO₂) or lithium nickel oxide (LiNiO₂), a compound substituted with one or more transition metals, lithium manganese oxide such as LiMnO₃ or LiMn₂O₃, lithium copper oxide, vanadium oxide such as LiV₃O₈, LiFe₃O₄, V₂O₅, or Cu₂V₂O₇, Ni-site type lithium nickel oxide, lithium manganese composite oxide, a sulfur compound, or a combination thereof, but one or more embodiments are not limited thereto.

The negative electrode current collector and the positive electrode current collector may be provided in a plate shape having a certain thickness and thus may be provided to support the negative electrode active material and the positive electrode active material, respectively.

Typically, a copper metal is mainly used in the negative electrode current collector, and an aluminum metal is mainly used in the positive electrode current collector. However, one or more embodiments are not limited thereto, and any material may be used as long as the material does not cause chemical changes in the cell and has conductivity.

The negative electrode and the positive electrode may further include at least one of a conductive material and a binder as necessary. In particular, the positive electrode may further include various additives for the purpose of supplementing or improving electrochemical characteristics.

The conductive material may be a material that improves conductivity. As the conductive material, any material may be used as long as the material does not cause chemical changes in a battery and has conductivity. For example, the conductive material may include graphite, carbon black, conductive fiber such as carbon fiber or metal fiber, conductive whisker such as fluorinated carbon, an aluminum powder, a nickel metal powder, or zinc oxide potassium titanate, a conductive metal oxide such as titanium oxide, a conductive material such as a polyphenylene derivative, or a combination thereof, but one or more embodiments are not limited thereto.

The binder may be a material that assists in bonding the negative electrode current collector to the negative electrode active material or assists in bonding the positive electrode current collector to the positive electrode active material. For example, the binder may include polyvinylidene fluoride (PVDF), polyacrylonitrile, polymethyl methacrylate, styrene butadiene rubber (SBR), carboxyl methyl cellulose (CMC), or the like, but one or more embodiments are not limited thereto.

The solid electrolyte layer may include a solid electrolyte.

The solid electrolyte may be a solid electrolyte that includes lithium ions having ionic conductivity and is capable of moving electrons or ions.

The solid electrolyte include a sulfide-based solid electrolyte material such as LGPS (Li₁₀GeP₂S₁₂), LSPSCl (Li_{9.54}Si_{1.74}P_{1.44}S_{11.7}Cl_{0.3}), or argyrodite, an oxide-based solid electrolyte material such as Perovskite (LLTO), Garnet (LLZO), NASICON, or LISICON, or a polymer-based electrolyte material such as polyethylene oxide (PEO), but one or more embodiments are not limited thereto.

The solid electrolyte may be mixed with the positive electrode active material to form one layer. For example, a raw material powder of the solid electrolyte and a raw material of the positive electrode active material may be mixed to form the solid electrolyte layer and the positive electrode active material layer that are mixed or in close contact with each other.

In the art, raw materials of the negative electrode active material, the solid electrolyte, and the positive electrode active material are all provided as solid powders. These solid powders may be commonly prepared in the form of a slurry. A slurry is a suspension formed by dispersing a solid in a solvent. When the viscosity of the slurry is excessively high, a material is difficult to apply, when the dispersibility of the slurry is low, the uniformity of a material is low, and the concentration and compressibility of the slurry determine the density of a material.

The cell manufacturing unit 10 may prepare each of the negative electrode active material, the solid electrolyte, and the positive electrode active material, which are provided as powders, into the forms of slurries and may sequentially stack the forms of slurries to form the negative electrode active material layer, the solid electrolyte layer, and the positive electrode active material layer.

Different solvents may be provided according to used raw materials, and the slurries may be prepared under appropriate manufacturing conditions (temperature, humidity, and the like) to have certain viscosity, dispersibility, concentration, and compressibility. Each of the slurries may be stacked through a method commonly used in the art, such as coating, dipping, or spraying.

An ion transfer speed and a lifetime of the negative electrode active material layer, the solid electrolyte layer, and the positive electrode active material layer may be controlled by a thickness, a density, and uniformity.

In the cell manufacturing unit 10, at least one pore may be formed at an interlayer interface or inside each layer of the negative electrode active material layer, the solid electrolyte layer, or the positive electrode active material layer, or at least one foreign material may flow in from the outside.

In an embodiment, the cell manufacturing unit 10 may manufacture a mono-cell. The mono-cell may be a single cell including the negative electrode, the solid electrolyte, and the positive electrode.

In another embodiment, the cell manufacturing unit 10 may manufacture a stack cell. The stack cell may be a cell in which the mono-cell is provided as a plurality of mono-cells, and the plurality of mono-cells are stacked.

The stack cell may include a bipolar cell which is widely known in the art. The bipolar cell includes a bipolar electrode and an electrolyte. The bipolar electrode is an electrode in which the negative electrode active material layer and the positive electrode active material layer are disposed on opposite surfaces of one current collector. The bipolar cell is manufactured by alternately stacking the bipolar electrode and the solid electrolyte layer. Accordingly, the bipolar cell may have a structure that is similar to that of a cell in which the plurality of mono-cells are stacked.

The pressing unit 20 may be provided to uniformly press the cell.

The pressing unit 20 may be disposed subsequent to the cell manufacturing unit 10 and may receive the cell from the cell manufacturing unit 10.

The pressing unit 20 may be provided in a plate shape or roller shape capable of applying uniform pressure to a certain area. However, the shape of the pressing unit 20 is not limited thereto.

The pressing unit 20 may press the cell in one direction of an upward direction or a downward direction or may press the cell in both directions of the upward direction and the downward direction. However, a pressing method of the pressing unit 20 is not limited thereto.

As the pressing unit 20 uniformly presses the cell, at least some of pores inside the cell may be removed.

As the pressing unit 20 uniformly presses the cell, an interface between the negative electrode active material layer and the solid electrolyte layer or an interface between the solid electrolyte layer and the positive electrode active material layer may be firmly attached to each other.

The imaging unit 30 may be provided to radiograph the cell to obtain an image (raw image).

The imaging unit 30 may obtain a first image by photographing the cell manufactured in the cell manufacturing unit 10 and may obtain a second image by photographing the cell pressed by the pressing unit 20.

That is, the imaging unit 30 may obtain the first image by photographing a state before the cell is pressed by the pressing unit 20 and may obtain the second image by photographing a state after the cell is pressed by the pressing unit 20.

The imaging unit 30 may be provided as a typical X-ray device or a three-dimensional computed tomography (CT) scanner.

The three-dimensional CT scanner is an X-ray tomography device and is a device that uses X-rays to generate a cross-sectional image of a three-dimensional object. An image obtained from the CT scanner is obtained by photographing a three-dimensional object at various angles, consecutively obtaining cross-sectional images consisting of pixels, and stacking and reconstructing the plurality of obtained cross-sectional images into a three-dimensional image consisting of voxels. Therefore, although the three-dimensional image is a three-dimensional video image, a tomogram of an object may be extracted as a two-dimensional cross-sectional image.

The first image and the second image may be two-dimensional images obtained from the X-ray device or may be a plurality of tomographic images extracted from a three-dimensional image obtained from the three-dimensional CT scanner.

The collection unit 40 may be provided to collect the pressed cell.

The collection unit 40 may be disposed subsequent to the pressing unit 20 and may receive the pressed cell from the pressing unit 20.

The collection unit 40 may collect the cell after the imaging unit 30 photographs the pressed cell to obtain the second image.

The collection unit 40 may be provided to collect the cell when the performance of the cell is suitable and may discard the cell when the performance of the cell is unsuitable.

The control unit 50 may control the overall operations of the cell manufacturing unit 10, the pressing unit 20, the imaging unit 30, and the collection unit 40.

The control unit 50 may process the first image or the second image obtained by the imaging unit 30.

The control unit 50 may process the first image to detect first inactive area information and may process the second image to detect second inactive area information.

The first inactive area information or the second inactive area information may be information about at least one of a brightness value, a brightness distribution, a pixel number, a pixel size, and a pixel area which are for each pixel of the first image and the second image.

By using the brightness value or brightness distribution for each pixel, the control unit 50 may distinguish between a first inactive area and a first active area in the first image and may distinguish between a second inactive area and a second active area in the second image.

In addition, by using the pixel number, the control unit 50 may measure the number of pixels occupying the first inactive area in the first image and may measure the number of pixels occupying the second inactive area in the second image.

In addition, by using the pixel size, the control unit 50 may measure a size of the first inactive area in the first image and may measure a size of the second inactive area in the second image.

In addition, by using the pixel area, the control unit 50 may measure an area of the first inactive area in the first image and may measure an area of the second inactive area in the second image.

The control unit 50 may derive the inactivity of the cell by using the first inactive area information or the second inactive area information.

The inactivity may represent a degree or ratio by which the first inactive area occupies the first image or a degree or ratio by which the second inactive area occupies the second image.

The inactivity may be used as an approximate value of the performance of the cell. The inactivity may be an index for determining whether the performance of the cell is suitable.

The inactivity of the cell may be calculated according to Equation 1 below.

$$Inactivity ( \% ) = [ area {A}_{2} of second inactive area / total area {A}_{total} inside cell ] \times 100. \qquad [ Equation 1 ]$$

The control unit 50 may compare the inactivity of the cell with a preset reference value to determine the suitability of the performance of the cell.

The reference value may be 0.1% or less. Accordingly, only when the inactivity is 0.1% or less, the cell may be determined to be suitable.

The control unit 50 may include an image processing unit, a calculation performing unit, and a determination unit.

The image processing unit may receive the first image or the second image from the imaging unit 30.

The image processing unit may process the first image to detect the first inactive area information and may process the second image to detect the second inactive area information.

The calculation performing unit may derive the inactivity of the cell by using the first inactive area information or the second inactive area information.

The determination unit may compare the inactivity with a preset reference value to determine the suitability of the performance of the cell.

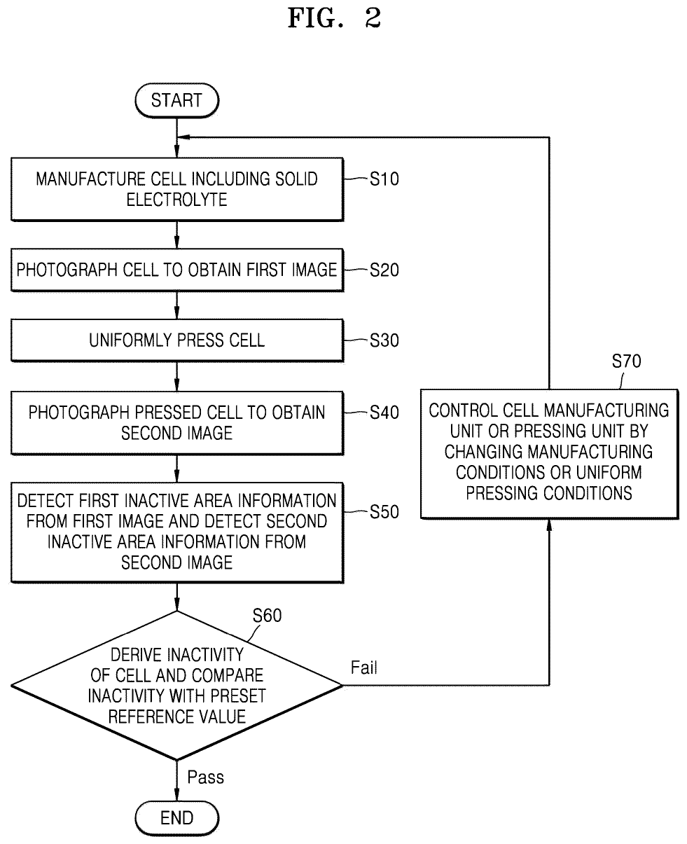

FIG. 2 is a flowchart briefly illustrating a method of manufacturing an all-solid state battery according to an embodiment of the present disclosure. Hereinafter, each operation of the flowchart will be described in detail.

Referring to FIGS. 1 and 2, the method of manufacturing an all-solid state battery according to an embodiment of the present disclosure may include operation S10 of manufacturing, by a cell manufacturing unit, a cell including a solid electrolyte, operation S20 of radiographing, by an imaging unit, the cell to obtain a first image, operation S30 of uniformly pressing, by the pressing unit, the cell, operation S40 of radiographing, by the imaging unit, the pressed cell to obtain a second image, operation S50 of processing, by a control unit, the first image to detect first inactive area information, and processing the second image to detect second inactive area information, and operation S60 of deriving, by the control unit, the inactivity of the cell by using the first inactive area information or the second inactive area information, and comparing the inactivity of the cell with a preset reference value to determine whether the cell is suitable.

In addition, according to an embodiment, after operation S60 of determining whether the cell is defective, when it is determined that the cell is unsuitable according to the reference value, the method may further include operation S70 of controlling, by the control unit, the cell manufacturing unit or the pressing unit by changing manufacturing conditions or uniform pressing conditions of the cell by using the first inactive area information or the second inactive area information.

In operation S10 of manufacturing the cell, the cell is manufactured by a cell manufacturing unit 10.

Specifically, the cell is manufactured in a layered structure in which the negative electrode active material layer, the solid electrolyte layer, and the negative electrode active material layer are sequentially stacked between the negative electrode current collector and the positive electrode current collector.

In operation S10 of manufacturing the cell, at least one pore may be formed at an interlayer interface or inside each layer of the negative electrode active material layer, the solid electrolyte layer, or the positive electrode active material layer, or at least one foreign material may flow in from the outside.

When the pores or foreign materials are preset inside each layer or at the interlayer interface, a portion in which the pores or foreign materials are present may become electrochemically inactive due to a lower density or a formed nodule compared to other portions.

In operation S20 of obtaining the first image, the manufactured cell is radiographed by an imaging unit 30.

The imaging unit 30 may be provided as an X-ray device or a three-dimensional CT scanner, and the imaging unit 30 may photograph the manufactured cell to obtain the first image.

The first image may be a two-dimensional image obtained from the X-ray device.

The first image may be a plurality of tomographic images extracted from a three-dimensional image obtained from the three-dimensional CT scanner.

In operation S30 of uniformly pressing the cell, the cell may be uniformly pressed by a pressing unit 20.

As the cell is pressed, the negative electrode, the solid electrolyte, and the positive electrode may be compressed. Thus, the interior of the cell may be densified at a high density.

In operation S40 of obtaining the second image, the pressed cell is radiographed by the imaging unit 30.

The imaging unit 30 may be provided as an X-ray device or a three-dimensional CT scanner, and in this case, the imaging unit 30 may be identical to that used in operation S20 of obtaining the first image.

The imaging unit 30 may photograph the pressed cell to obtain the second image.

The second image may be a two-dimensional image obtained from the X-ray device.

The second image may be a plurality of tomographic images extracted from a three-dimensional image obtained from the three-dimensional CT scanner.

In operation S50 of detecting the inactive area information, a control unit 50 processes the first image to detect the first inactive area information and processes the second image to detect the second inactive area information.

The first inactive area information and the second inactive area information may include at least one of a brightness value, a brightness distribution, a pixel number, a pixel size, and a pixel area which are for each pixel of the first image and the second image.

In operation S60 of determining whether the cell is suitable, the control unit 50 may use the first inactive area information or the second inactive area information to derive the inactivity of the cell and may compare the inactivity with the preset reference value to determine whether the cell is suitable.

According to an embodiment, the inactivity is calculated according to Equation 1 below.

$$Inactivity ( \% ) = [ area {A}_{2} of second inactive area / total area {A}_{total} inside cell ] \times 100. \qquad [ Equation 1 ]$$

Accordingly, it may be seen that the inactivity is a percentage (%) of an area of the inactive area to the total area inside the cell.

The inactivity may be an approximate value of the performance of the cell, and performance according to a cell area may be approximately derived without electrical and chemical evaluation of the cell.

A reference value of the inactivity may be 0.1% or less. Accordingly, only when the inactivity is 0.1% or less, the cell may be determined to be suitable, and a manufacturing process may be completed.

When the inactivity is determined to be unsuitable according to the reference value, operation S70 of controlling the cell manufacturing unit or the pressing unit may be performed subsequently.

In operation S70 of controlling the cell manufacturing unit or the pressing unit, the control unit 50 changes the manufacturing conditions or the uniform pressing conditions of the cell by using the first inactive area information or the second inactive area information.

The control unit 50 may compare the first inactive area information of the first image with the second inactive area information of the second image and may change the manufacturing conditions or the uniform pressing conditions of the cell according to a rate of change in the inactivity of the cell before and after pressing.

In order to reflect the changed manufacturing conditions or uniform pressing conditions of the cell in a manufacturing process to be performed subsequently, the control unit 50 may control the cell manufacturing unit 10 or the pressing unit 20.

That is, the cause of the unsuitable performance of the cell is analyzed, the control unit 50 changes the manufacturing conditions or the uniform pressing conditions of the cell according to a result of the analysis, and then a process to be performed subsequently is supplemented to manufacture a new cell.

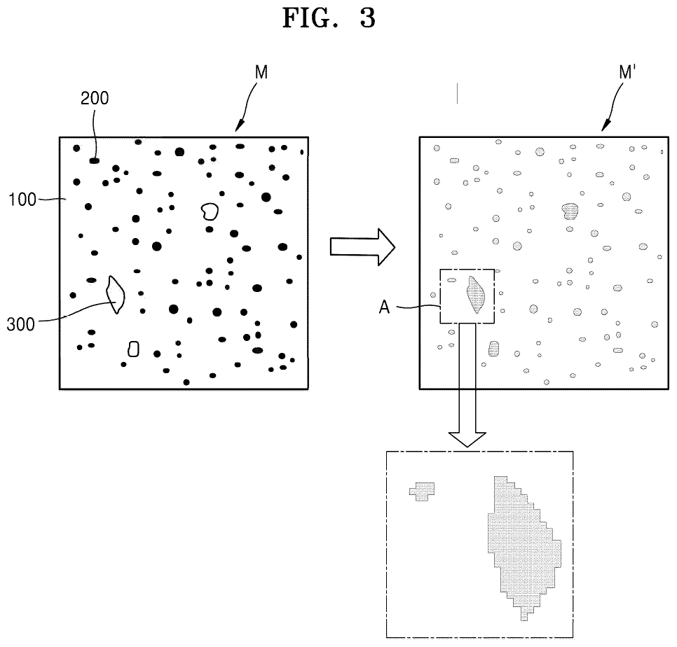

FIG. 3 shows conceptual diagrams for describing a method of detecting inactive area information by performing image processing on an image. Operation S50 of detecting the inactive area information, and the control unit 50 will be described in more detail with reference to FIG. 3.

However, since a method of detecting the first inactive area information by processing the first image is identical to a method of detecting the second inactive area information by processing the second image, hereinafter, the first image and the second image are collectively referred to as an image, and the first inactive area and the second inactive area are collectively referred to as an inactive area.

Referring to FIG. 3, the control unit 50 may derive a processed image M′ by performing image processing on an original image M received from the imaging unit 30.

The image processing may be a process of extracting a brightness value or a brightness distribution of each pixel from the image M and distinguishing between the inactive area and the active area in the image M by using the extracted brightness value or brightness distribution.

For example, the image M may include a gray area 100, a black area 200, and a white area 300.

The gray area 100 is an area in which the active area is photographed.

The gray area 100 may be one of the negative electrode active material, the solid electrolyte, or the positive electrode active material, or a mixed portion thereof according to whether the image M is a tomographic image of any portion of the cell.

The black area 200 and the white area 300 are areas in which the inactive area is photographed.

The black area 200 has lower brightness than the gray area 100 to appear darker and is an area in which pores inside the cell are photographed.

The white area 300 has higher brightness than the gray area 100 to appear brighter and is an area in which foreign materials inside the cell are photographed.

In operation S50 of detecting the inactive area information, the control unit 50 may extract the black area 200 and the white area 300 from the image M and may distinguish the black area 200 and the white area 300 from the gray area 100.

Referring to an enlarged view of part A of the processed image M′, the control unit 50 may pixelate the image M to extract information of each pixel. The control unit 50 may mark a pixel of the black area 200 and a pixel of the white area 300 with a different color or boundary line to be distinguished from a pixel of the gray area 100.

That is, an area occupied by the pores or foreign materials are visualized as pixels. The visualized pixels refer to pixels occupying the inactive area.

The control unit 50 may distinguish and mark pixels occupying the inactive area among all pixels of the image M.

The control unit 50 may measure the number of pixels occupying the inactive area and may measure a pixel size or pixel area of one pixel.

According to an embodiment, operation S50 of detecting the inactive area information may further include the following operations:
an operation of measuring a pixel number Nₓ (x=1 or 2) in the inactive area and the total pixel number Nₜₒₜₐₗ inside the cell from the image,
an operation of calculating an area Aₚᵢₓₑₗ per pixel according to radiographic conditions described above, and
an operation of deriving an area Aₓ (x=1 or 2) of the inactive area and the total area Aₜₒₜₐₗ inside the cell.

In the operation of measuring the pixel number Nₓ of the inactive area and the total pixel number Nₜₒₜₐₗ inside the cell from the image, the number of pixels visualized in operation S50 of detecting the inactive area may be measured.

In this case, the total pixel number Nₜₒₜₐₗ inside the cell may refer to a pixel number of the entire area occupying the interior of the cell and may be the total pixel number of the entire area including the inactive area and the active area.

In the operation of calculating the area Aₚᵢₓₑₗ per pixel according to the radiographic conditions, the area Aₚᵢₓₑₗ per pixel in the image is obtained according to the radiographic conditions of the cell.

The area Aₚᵢₓₑₗ per pixel may be calculated in consideration of a magnification, a field of view (FOV), and resolution set when a CT scan is performed on the cell.

In the operation of deriving the area Aₓ of the inactive area and the total area Aₜₒₜₐₗ inside the cell, the area Aₚᵢₓₑₗ per pixel may be multiplied by each of the pixel number Nₓ of the inactive area and the total pixel number Nₜₒₜₐₗ inside the cell to derive the area Aₓ of the inactive area and the total area Aₜₒₜₐₗ inside the cell.

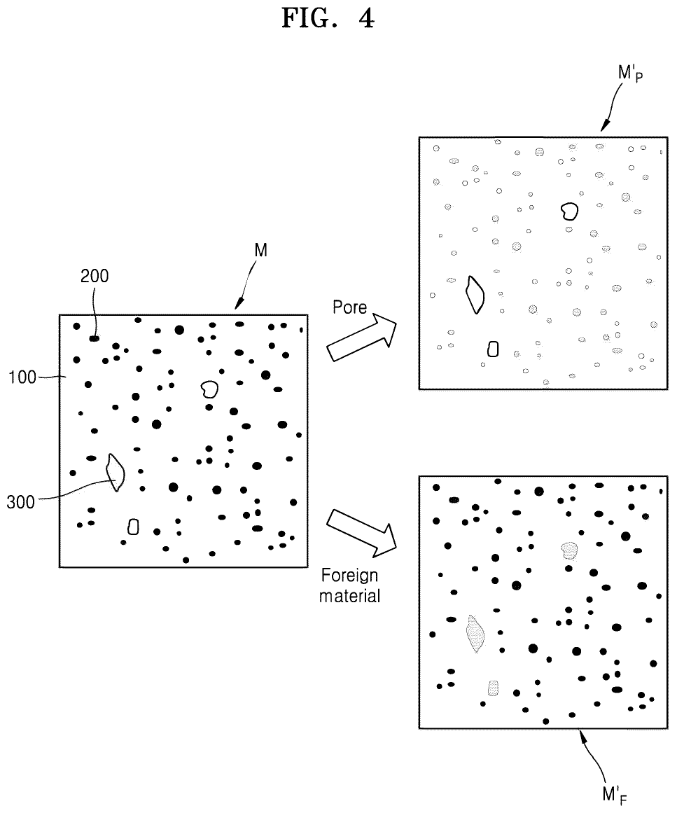

FIG. 4 shows conceptual diagrams for describing a method of processing an image by distinguishing between an inactive area due to pores and an inactive area due to foreign materials in an image.

Referring to FIG. 4, when image processing is performed on the original image M received from the imaging unit 30, the control unit 50 may derive each of an image M′ₚ processed by focusing on pores and an image M′_{F} processed by focusing on foreign materials.

In operation S50 of detecting the inactive area information, when the first image is compared with the second image, inactivity increase/decrease trends of the black area 200 and the white area 300 may appear oppositely.

When the cell is pressed by the pressing unit 20, as the pores inside the cell are reduced or removed, the number of black areas 200 may be decreased, or a size or area thereof may be decreased, and the gray area 100 may be further densified.

On the other hand, when the cell is pressed by the pressing unit 20, as the foreign materials inside the cell are compressed and an area thereof is increased, a size or area of the white area 300 may be increased.

For example, when the plurality of foreign materials are concentratedly distributed only in a portion inside the cell, while the cell undergoes operation S30 of uniformly pressing the cell, the inactivity of the entire cell may be suitable to a performance reference value, but the inactivity of the inactive area formed by the foreign materials may be locally increased. Since the ion conductivity of the cell in the inactive area is very low, an ion transfer speed and a lifetime of the cell are greatly reduced, which makes it difficult to regard the performance of the cell to be suitable.

Therefore, it may be desirable that the inactivity is uniformly reduced over the entire area of the cell when the cell is pressed by the pressing unit 20, and the control unit 50 may need to derive each of the image M′ₚ processed by focusing the pores from one image M and the image M′_{F} processed by focusing the foreign materials from one image M.

The control unit 50 may be provided to distinguish between the inactive area formed by the pores and the inactive area formed by the foreign materials in the image M and process each of the image M′ₚ and the image M′_{F}.

The control unit 50 may derive the inactivity due to the pores from the image M′ₚ processed by focusing the pores and may derive the inactivity due to the foreign materials from the image M′_{F} processed by focusing the foreign materials.

The control unit 50 may derive each of a rate of change in inactivity due to the pores and a rate of change in inactivity due to the foreign materials.

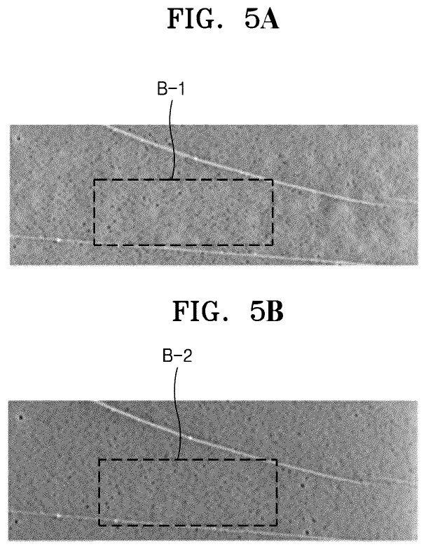

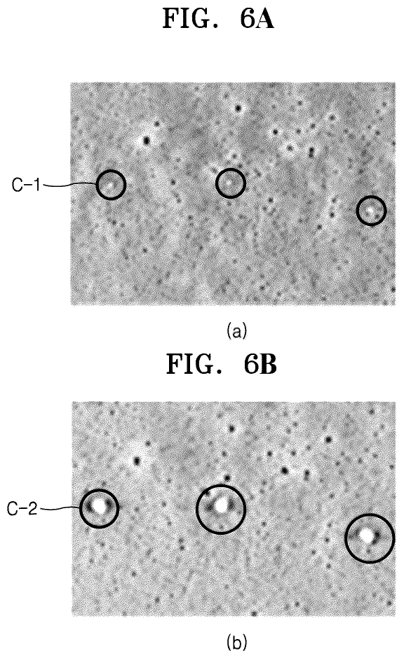

FIGS. 5 and 6 show enlarged images of a portion suitable for analyzing a decrease or increase trend of the inactivity in a CT tomographic image of a cell manufactured as an embodiment. Hereinafter, operation S70 of controlling the cell manufacturing unit or the pressing unit by changing the manufacturing conditions or uniform pressing conditions of the cell will be described in detail with reference to FIGS. 5 and 6. The cell and photographing conditions of FIGS. 5 and 6 are as follows.

In an embodiment, the cell is a mono-cell having an area of 12 cm² (40 mm×30 mm) and a thickness of 0.15 mm (±0.03 mm). Before and after the cell is pressed by the pressing unit 20, the cell was photographed by a three-dimensional CT scanner to obtain a first image and a second image.

Photographing conditions of the CT scanner are an X-ray tube voltage of 140 kV, an X-ray tube current of 100 μA, a magnification of 5.5×, a FOV of 27.5 mm×27.5 mm, and an image resolution of 21.63 μm.

FIGS. 5A and 5B show views showing a case in which inactivity is reduced when the first image is compared with the second image.

FIG. 5A shows the first image, and FIG. 5B shows the second image.

In comparison between FIG. 5A and FIG. 5B, it may be confirmed that white lines are present at the same position, but there is no difference before and after operation S30 of uniformly pressing the cell. Since the white line appears to be caused by crumpling or folding of the cell, it may be determined that the white line is unrelated to operation S30 of uniformly pressing the cell.

B-1 shown in FIG. 5A and B-2 shown in FIG. 5B are at the same position in one cross section of a negative electrode layer of the cell. A plurality of black areas seen in B-1 are pores before the cell is pressed, and a plurality of black areas seen in B-2 are pores after the cell is pressed.

In comparison between the black areas of B-1 and the black areas of B-2, it may be confirmed that the number and size of the black areas have decreased. This means that layers forming the interior of the cell are attached to each other by pressure applied to the cell, and a plurality of pores included inside the cell are combined or removed.

However, when inactivity derived from FIG. 5B exceeds 0.1%, it is necessary to change the manufacturing conditions or the uniform pressing conditions of the cell.

As an example, when the inactivity of the cell uniformly pressed at a pressure of 50 tons for 10 minutes exceeds 0.1%, an inactive area formed by the pores may be the cause.

In this case, in operation S30 of uniformly pressing the cell, the control unit 50 controls the pressing unit 20 to apply a pressure of 50 tons or more to the cell or change a pressing time to 10 minutes or more.

Meanwhile, in operation S10 of manufacturing the cell, the control unit 50 may control the cell manufacturing unit 10 to consider changes in preparation conditions of a slurry of the negative electrode active material, the solid electrolyte, or the positive electrode active material, or a stacking method thereof.

FIGS. 6A and 6B show images showing a case in which inactivity is increased when the first image is compared with the second image.

FIG. 6A shows the first image, and FIG. 6B shows the second image. In this case, C-1 shown in FIG. 6A and C-2 shown in FIG. 6B are at the same position in one cross section of the negative electrode layer of the cell.

White areas seen in C-1 are foreign materials before the cell is pressed, and white areas seen in C-2 are foreign materials after the cell is pressed.

In comparison between the white areas of C-1 and the white areas of C-2, it may be confirmed that a size thereof has expanded. This means that, while the foreign materials are spread thinly by pressure applied to the cell, an area thereof may be expanded, and thus ionic conductivity may be decreased in an area in which the foreign materials are present.

In such a case, it may be determined that it is important to prevent the inflow of foreign materials in operation S10 of manufacturing the cell or operation S30 of uniformly pressing the cell.

Accordingly, each raw material constituting the negative electrode active material layer, the positive electrode active material layer, or the solid electrolyte layer may be prepared with higher purity, or manufacturing conditions or methods may be changed when a slurry is prepared from each raw material.

Meanwhile, manufacturing environments in operation S10 of manufacturing the cell or operation S30 of uniformly pressing the cell may be improved.

The present disclosure has been described with reference to embodiments shown in the accompanying drawings, but this is merely illustrative, and those skilled in the art will understand that various modifications and other equivalent embodiments are possible therefrom. Therefore, the true scope of the present disclosure should be determined only by the appended claims.

### INDUSTRIAL APPLICABILITY

The present disclosure relates to a method and apparatus for manufacturing a solid-state battery. There may be provided an apparatus for manufacturing a solid-state battery in which the performance of a cell is predicted through a non-destructive inspection, thereby evaluating a manufacturing process of the cell.

Related national research and development projects
Project identification number: 1415178681
Project number: 20012349
Ministry name: Ministry of Economy and Finance
Project management (professional) organization name: Korea Evaluation Institute of Industrial Technology
Research project name: Development of lithium-based next-generation secondary battery performance enhancement and manufacturing technology
Research subject name: Development of manufacturing equipment for all-solid state battery cells over 50 cm²
Contribution rate: 1/1
Name of organization carrying out project: MEERECOMPANY Inc.
Research period: 2022 Jan. 1-2022 Dec. 31

What is claimed is:

1. A method of manufacturing an all-solid state battery, the method comprising:
manufacturing, by a cell manufacturing unit, a cell comprising a solid electrolyte;
radiographing, by an imaging unit, the cell to obtain a first image;
uniformly pressing, by a pressing unit, the cell;
radiographing, by the imaging unit, the pressed cell to obtain a second image;
processing, by a control unit, the first image to detect first inactive area information, and processing the second image to detect second inactive area information; and
deriving, by the control unit, inactivity of the cell by using the first inactive area information or the second inactive area information, and comparing the inactivity of the cell with a preset reference value to determine whether the cell is suitable.

2. The method of claim 1, further comprising, after the determining of whether the cell is suitable, when it is determined that the cell is unsuitable according to the reference value, controlling, by the control unit, the cell manufacturing unit or the pressing unit by changing manufacturing conditions or uniform pressing conditions of the cell by using the first inactive area information or the second inactive area information.

3. The method of claim 2, wherein the controlling of the cell manufacturing unit or the pressing unit comprises comparing the first inactive area information of the first image with the second inactive area information of the second image, and changing the manufacturing conditions or the uniform pressing conditions of the cell according to a rate of change in inactivity of the cell before and after the pressing.

4. The method of claim 1, wherein the first inactive area information and the second inactive area information are information about at least one of a brightness value, a brightness distribution, a pixel number, a pixel size, and a pixel area which are for each pixel of the first image and the second image.

5. The method of claim 1, wherein the determining of whether the cell is suitable comprises deriving the inactivity of the cell according to Equation 1 below:
$$Inactivity ( \% ) = [ area {A}_{2} of second inactive area / total area {A}_{total} inside cell ] \times 100. \qquad [ Equation 1 ]$$

6. The method of claim 1, wherein the cell is a mono-cell or a stack cell.

7. The method of claim 1, wherein the imaging unit is an X-ray device or a three-dimensional computed tomography (CT) scanner.

8. An apparatus for manufacturing an all-solid state battery, the apparatus comprising:
a cell manufacturing unit configured to manufacture a cell comprising a solid electrolyte;
a pressing unit configured to uniformly press the cell;
an imaging unit configured to obtain a first image or a second image by radiographing the cell; and
a control unit configured to process the first image to detect first inactive area information, process the second image to detect second inactive area information, derive inactivity of the cell by using the first inactive area information or the second inactive area information, and compare the inactivity of the cell with a preset reference value to determine whether the cell is suitable.

9. The apparatus of claim 8, wherein when it is determined that the cell is unsuitable according to the reference value, the control unit is further configured to control the cell manufacturing unit or the pressing unit by changing manufacturing conditions or uniform pressing conditions of the cell by using the first inactive area information or the second inactive area information.

10. The apparatus of claim 9, wherein when the control unit controls the cell manufacturing unit or the pressing unit, the first inactive area information of the first image is compared with the second inactive area information of the second image, and the manufacturing conditions or the uniform pressing conditions of the cell are changed according to a rate of change in inactivity of the cell before and after the pressing.

11. The apparatus of claim 8, wherein the first inactive area information and the second inactive area information are information about at least one of a brightness value, a brightness distribution, a pixel number, a pixel size, and a pixel area for each pixel of the first image and the second image.

12. The apparatus of claim 8, wherein, in the determining of whether the cell is suitable, the inactivity of the cell is derived according to Equation 1 below:
$$Inactivity ( \% ) = [ area {A}_{2} of second inactive area / total area {A}_{total} inside cell ] \times 100. \qquad [ Equation 1 ]$$

13. The apparatus of claim 8, wherein the cell is a mono-cell or a stack cell.

14. The apparatus of claim 8, wherein the imaging unit is an X-ray device or a three-dimensional computed tomography (CT) scanner.
